(19) United States
(12) Patent Application Publication
(10) Pub. No.: US 2014/0337337 A1
(43) Pub. Date: Nov. 13, 2014

(54) Similarity Score Lookup and Representation

(71) Applicants: Lijiang Chen, Beijing (CN); Hui-Man Hou, Beijing (CN); Shimin Chen, Beijing (CN)

(72) Inventors: Lijiang Chen, Beijing (CN); Hui-Man Hou, Beijing (CN); Shimin Chen, Beijing (CN)

(21) Appl. No.: 14/372,712

(22) PCT Filed: Apr. 27, 2012
(86) PCT No.: PCT/CN2012/074840

§ 371 Date: Jul. 16, 2014

(51) Int. Cl. G06F 17/30

(52) U.S. Cl. CPC G06F 17/30595
USPC 707/736; 707/748

(57) ABSTRACT

Facilitating information retrieval and improving similarity score computations among objects, via a compactor component that interacts with a layered memory structure. Data structures (e.g., tuples) that are associated with objects can be compacted into a condensed format, via employing a layered memory structure. The system further includes a sorting component that is operatively coupled with the “compactor component”, to reduce memory space that is required to store and retrieve similarity scores related to various objects.

### BACKGROUND

With the advent of digital databases and communication networks, vast repositories of textual, multimedia and other content data have become readily available to public at large. Today, an important challenge in information sciences is developing intelligent interfaces for human-machine interaction which support computer users in their quest for relevant information.

The search space can contain heterogeneous information objects such as documents (web-pages, database records), objects represented by documents (movies, music, restaurants, products, and the like), users (authors, taggers, raters, readers), user tags, as provided by collaborative bookmarking systems, and other object types. These objects can be related to each other in several relation types. For example, documents can relate to other documents by referencing each other; a user might be related to a document through authorship relation, as a tagger (a user bookmarking the document), as a rater (a user rating the document), as a reader, or as mentioned in the page's content; users might relate to other users through typical social network relations; and tags might relate to the bookmark they are associated with, and also to their taggers.

Accordingly, typical information discovery methods can be based on contents such as: documents, users, other objects, and their relationships. Searches that incorporate personalization, social graphs, content, and personal recommendations are just some of the tasks that can take advantage of this newly formed environment.

A key task to content-based retrieval remains the similarity measurement of objects. For example, objects can be represented as points in a space domain, and measurements can be based on predetermined distance measurement. As such, computing pairwise similarity on large collections of objects is a task common to a variety of problems, such as classification, clustering, ranking, and cross-document referencing.

Many processes (classification, clustering, ranking, and the like) may require the computations of a large number of similarity measurements between objects. The efficiency of obtaining similarity measurements is critical to the efficiency of the entire algorithms. For example, such can be deemed significant when these processes are employed for supporting online services that require sub-second user response times.

A typical solution to reduce similarity computation cost is to pre-compute and store the similarity scores, and perform similarity score lookups online. An efficient way to represent and look up similarity scores is thus critical to the performance of this approach.

Typically, to manage ordering and retrieval, data sets can be routinely stored in high performance database systems. Row-based databases do not provide effective compression for storing similarity scores and therefore can incur large I/O overheads. While column-based compression is effective on sorted column values, such solutions mainly target large data analysis and do not support point lookup query well.

Other type of data structures such as hash tables and matrices can also be employed, which can employ functions to map keys to their associated values. For example, a combination hash keys can correspond for identifying various data values.

### BRIEF DESCRIPTION OF THE DRAWINGS

FIG. 1 illustrates a block diagram for a non-limiting system that facilitates similarity scoring and look up among multiple objects, according to an aspect of the subject disclosure.

FIG. 2 illustrates a compactor component that includes a sorting component and a divider component, according to a further aspect of the subject disclosure.

FIG. 3 illustrates a methodology of supplying an efficient similarity lookup and representation according to a particular aspect for the subject disclosure.

FIG. 4 illustrates a related methodology that can be employed by the compactor component in accordance with an aspect of the subject disclosure.

FIG. 5 illustrates a system for similarity look up and representation that employs an in-memory structure that interacts with a query look up component and compactor component according to a particular aspect of the subject disclosure.

FIG. 6 illustrates an inference component that can interact with a compactor component of the subject disclosure.

FIG. 7 illustrates a schematic diagram that represents an example for a networked or distributed computing environment in which aspects described herein can be implemented.

FIG. 8 illustrates a particular example of a suitable computing environment in which aspects described herein can be implemented.

### DETAILED DESCRIPTION

Several examples are now described with reference to the drawings, wherein like reference numerals are used to refer to like elements throughout. In the following description, for purposes of explanation, numerous specific details are set forth in order to provide a more thorough understanding of one or more aspects. It is evident, however, that such embodiments can be practiced without these specific details. In other instances, structures and devices are shown in block diagram form in order to facilitate describing one or more embodiments.

Various aspects of the subject disclosure facilitates similarity scoring and distance measurements by employing a compactor component that compacts the similarity score representations for data objects and further enables efficient query and on line look up associated therewith. Typically a similarity score represents a measure that approximates a semantic relationship (e.g., between content/meanings of two or more objects). The degree of similarity between objects in a database is often quantified by a distance measure, e.g., Euclidean distance, operating on the multi-dimensional data objects or the feature vectors extracted from the data objects. Other similarity measurements include but not limited to the comparison of inter-object link structures, and the comparison of certain probabilistic characteristics of objects. For example, a user can pose a query over encyclopedia database such as Wikipedia requesting particular information/article that is similar to a given article in terms of Euclidean distance of multi-dimensional texture feature vectors.

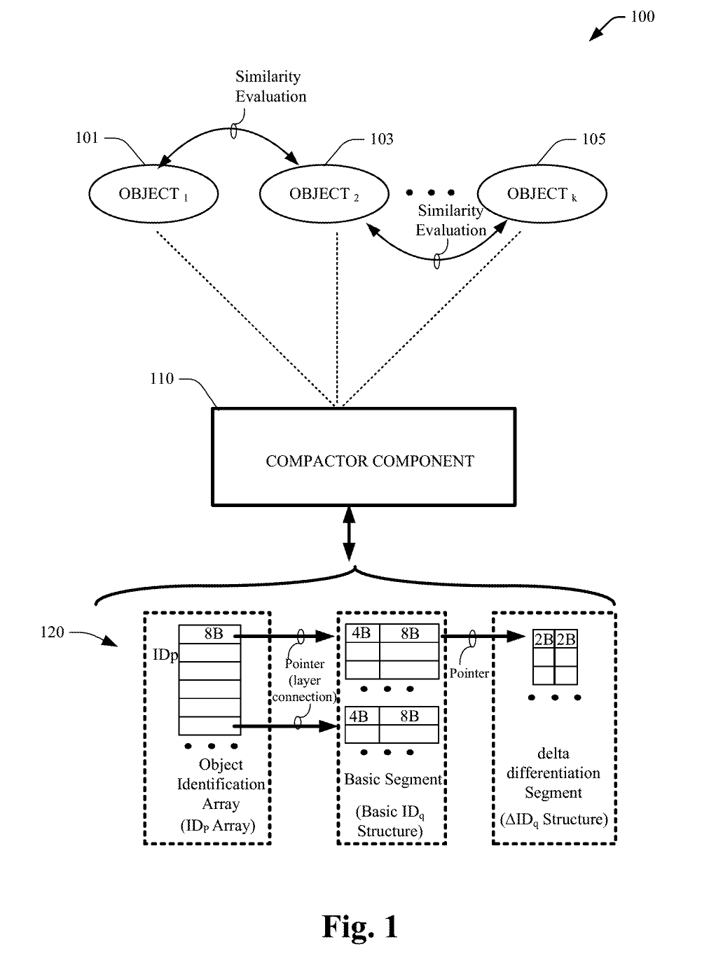

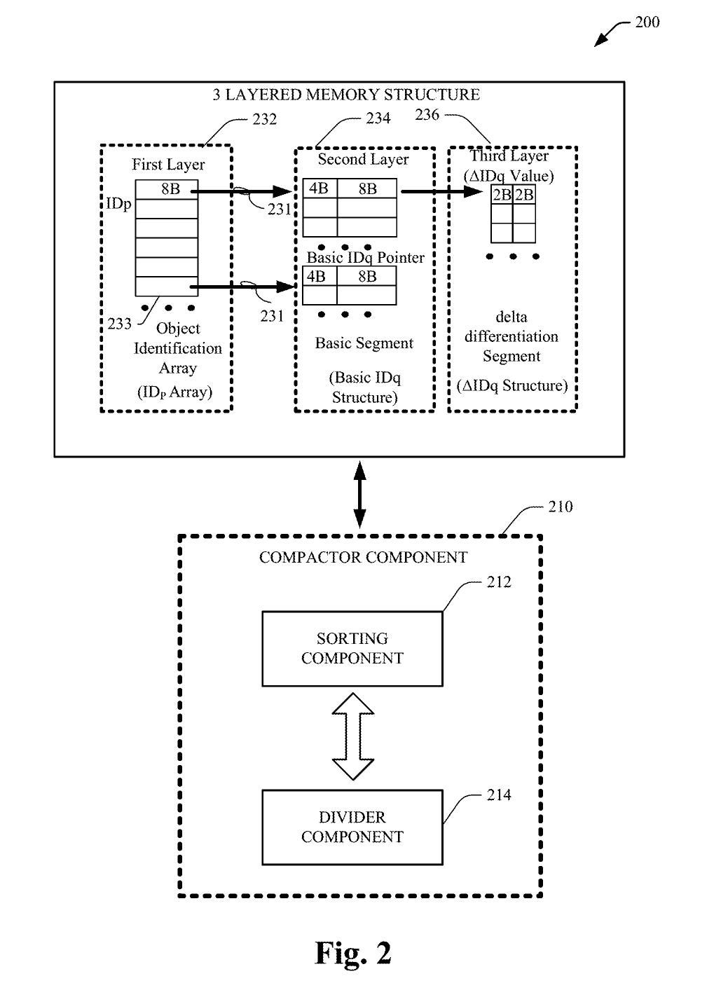

FIG. 1 illustrates a compactor component 110 that can interact with a plurality of objects 101, 103, 105 (k being an integer.) As such, two objects i and j can be represented as a three-tuple <i,j, score>, wherein i and j are object IDs ranging from 0 to N−1 (N being an integer), and score represents a floating point number ranging from 0 to 1, wherein “1” represents that object i and j are the same. In one particular aspect, considering a list of three-tuples, the compactor component 110 can supply a data structure that compactly stores the similarity scores (e.g., supplying space efficiency) and support efficient lookup operations (e.g., sub-second response time for retrieving or looking up 10 ̂4 to 10 ̂5 scores.) Such data structure can be in form of three layered memory structure 120 that is described in detail with reference to FIG. 2. It is noted that throughout the subject disclosure, reference to a “three layered memory” structure is to be construed as a layered memory structure that includes at least three layers, and hence structures having more than three layers are well within the realm of the subject matter disclosed.

Various aspects of the subject disclosure described herein are discussed in context of similarity score with respect to contents of the Wikipedia articles/objects and its arrangement. It is noted that such discussion is provided as a non-limiting example, and the subject disclosure can be implemented as part of other infatuation retrieval systems and similarity score implementations.

In general, the English Wikipedia dump file that contains all the Wikipedia articles of English language, can include more than 3 million articles—wherein each Wikipedia article explains a Wikipedia concept, which is the title of the article, for example. In such an arrangement, similarity scores between Wikipedia articles can be deemed valuable for Wikipedia-based text analysis.

In general, similarity/distance scores can typically remain sparse, wherein similarities between many pairs of objects can be 0 or close to 0, for example. For distance measurements, distances between many pairs of objects can be maximum distance or beyond a predetermined threshold. In such cases, it is often feasible to define a default similarity/distance score (0 or maximum distance) and typically store the other non-trivial scores. For example, for the similarity score of Wikipedia concepts, among pairs of 3 million English articles, there typically exists about 2 billion non-trivial scores. As an average, for a Wikipedia concept, there exists only about 680 non-zero similarity scores—wherein only 13% of the concepts have over 1000 non-zeros, and the maximum number of non-zeros for a single concept can reach 859179.

In this regard, a basic format of a similarity tuple can be represented by <IDp, IDq, score >, where IDp and IDq can represent 4-Byte integers, and the score indicates a 4-Byte floating point number. The IDp and IDq can represent the Wikipedia article IDs, ranging from 0 to 30 million. It is notes that English articles of Wikipedia can take 3 million IDs; with additional IDs being reserved for articles in other languages. To this end, a similarity score can represent a 32-bit floating point number ranging from 0 to 1, for example.

In order to achieve sub-second response times, it can be deemed efficient to maintain the non-zero similarity scores in memory, hence mitigating I/O operations. For example, considering that every similarity tuple can take at least 12 bytes -(hence at least 24 GB is typically employed to store all the 2 billion similarity scores in memory without considering storage overhead)—which represents a substantially larger number than the typical memory size in most machines.

In this regard, the compactor component 110 can substantially reduce a memory size requirement for storing the similarity scores. Such compactor component 110 can interact with and/or include a three-layer in-memory structure (e.g., centralized), which in context of the above example, can compact the 24 GB similarity scores into about 9.6 GB space, while supporting efficient lookup queries. Moreover, lookup operations can become readily efficient and sub-second response time for looking up 10 ̂4 to 10 ̂5 scores, can be obtained, for example.

FIG. 2 illustrates a particular system 200 according to an aspect of the subject disclosure, wherein the compactor component 210 can further include a sorting component 212 and a divider component 214. According to one particular aspect, the sorting component 212 can sort the tuples according to the <IDₚ, ID_{q}>order. In general, the records sharing the first ID remain contiguous, wherein the first ID can be extracted to build an index, so that the similarity records themselves do not typically require storing of the first ID.

As illustrated in FIG. 2, the first layer 232 can represent an index structure storing <IDₚ, pointertoID_{q}>, wherein pointertoID_{q}, 231 can further point (e.g., conceptually) to the first similarity record that has a first ID of IDₚ. The IDₚ can range from 0 to approximately 30 million, and an array having max(ID) entries can be allocated to the first layer.

The array index 233 can be represented by IDₚ, wherein O(1) lookup can occur (e.g., array[IDₚ]) for the first layer index, for example. In one particular aspect, size of the first layer 232 can be represented 8 Byte×3×10000000. It is noted that compared to the total data size, the size of the first layer 232 can remain relatively small, for example. Moreover, such O(1) provided by the array design can remain more efficient, as compared to another aspect, wherein the non-zero IDs can be compacted and queries require O (log NumOfID) binary searches.

Moreover, a divider component component 214 can divide an ID_{q} into two segments or parts, namely a, basicID_{q} (a basic segment), and a delta differentiation segment ΔID_{q}. In general, for many cases when considering similarity records sharing the same first ID, it is noted that the delta differentiation between subsequent ID_{q} can remain relatively small in substantial number of instances. Furthermore, the second layer 234 and the third layer 236 of the structure can be designed to further save space for storing ID_{q}.

For example, when the divider component 214 divides an ID_{q} into two parts namely, a basicID_{q} and a ΔID_{q}, the second-layer data structure 234 can contain a 4-byte basicID_{q} and an 8-byte pointertoΔID_{q}. Likewise, the third-layer data structure 236 can contain individual similarity records, consisting of a 2-byte ΔID_{q} and a 2-byte score. Initially considering the representation of ID_{q}, the pointer to ΔID_{q} in the second layer can point to the beginning of a set of similarity records, wherein typically all of which can share the same basicID_{q}. Moreover, the actual ID_{q} of a similarity record can be computed as basicID_{q}+ΔID_{q}.

The structure can be populated, such that for a given IDₚ, a set of similarity records can be sorted in ascending ID_{q} order. Next, the first ID_{q} can be selected as a basic ID_{q}, wherein for such record and the subsequent records, the ΔID_{q} can be computed as the difference between an ID_{q} and the basicID_{q} . Such ΔID_{q} and its corresponding score can subsequently be stored into the third-layer structure of the system 200. Such process can continue until an ID_{q} is encountered, wherein the ID_{q}−basicID_{q} cannot be represented by a 16-bit integer, for example. If so, a new basicID_{q} entry for such ID_{q} can then be created and further employed in computing the subsequent ΔID_{q} computation. For example, such process can compress 4-byte ID_{q} into 2-byte ΔID_{q}.

It is noted that similarity scores can range from a value of 0 to 1 (wherein a value of 1 indicates sameness of two articles.) In one particular aspect, typically four digits after the decimal point can represent the similarity scores in most cases. For such instances, a 2-byte integer can be employed to store the four digits after the decimal point in the third-layer data structure 236.

The third layer 236 of the structure can take (2B+2B)×2 billion=8 GB, for example—wherein in particular examples of practical implementations, the first layer 232 and the second layer 234 altogether can take about 1.6 GB. Likewise and in a particular example, the original 24 GB similarity scores can be compacted into 9.6 GB and loaded for efficient lookups.

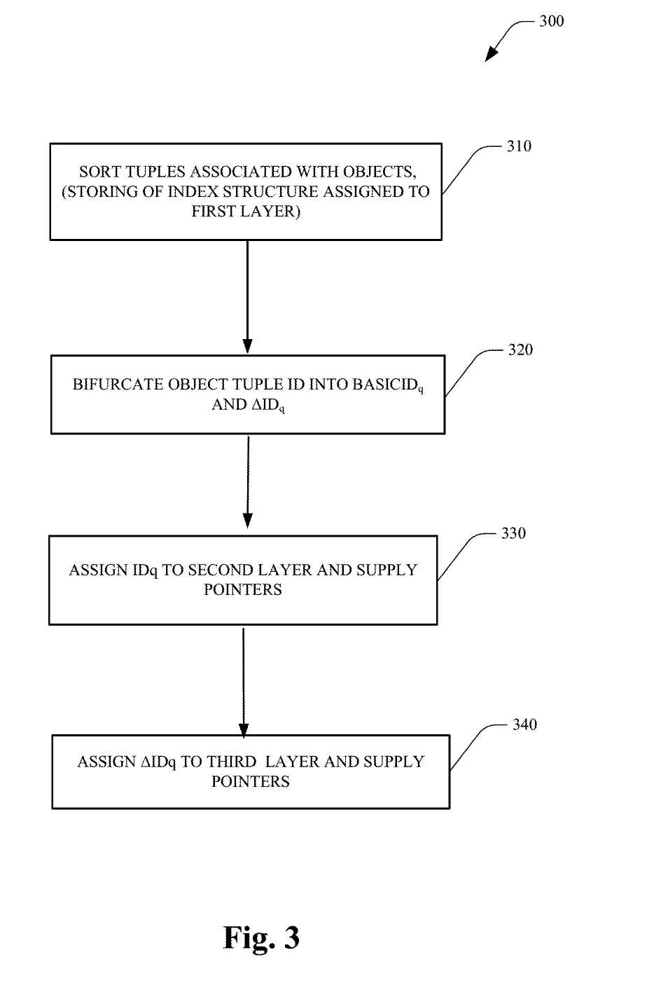

FIG. 3 illustrates a related methodology 300 of supplying an efficient similarity lookup and representation according to a particular aspect for the subject disclosure. While this example is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the subject disclosure. In addition, not all illustrated blocks, events or acts, may be required to implement a methodology in accordance with the subject innovation. Moreover, it is noted that the example method and other methods according to the innovation may be implemented in association with the method illustrated and described herein, as well as in association with other systems and apparatus not illustrated or described.

Initially and at 310 similarity tuples associated with objects and/or their similarity computations can be sorted according to an <IDₚ, ID_{q}>order, wherein a first layer can represent an index structure storing pointing to a first similarity record that has a first ID of ID_{P}. Subsequently, and at 320, a divider component can divide or separate the ID_{q} into two segments, namely a basicID_{q} and a ΔID_{q}, as described in detail above. Next and at 330, the basicID_{q} can be assigned to a second layer of a data structure with a pointer mechanism for pointing to ΔID_{q}, wherein such pointertoΔIDq in the second layer can point to the beginning of a set of similarity records, wherein typically all of which can share the same basicIDq. Likewise and at 440 the ΔID_{q} can be assigned to a third layer in such layering arrangement.

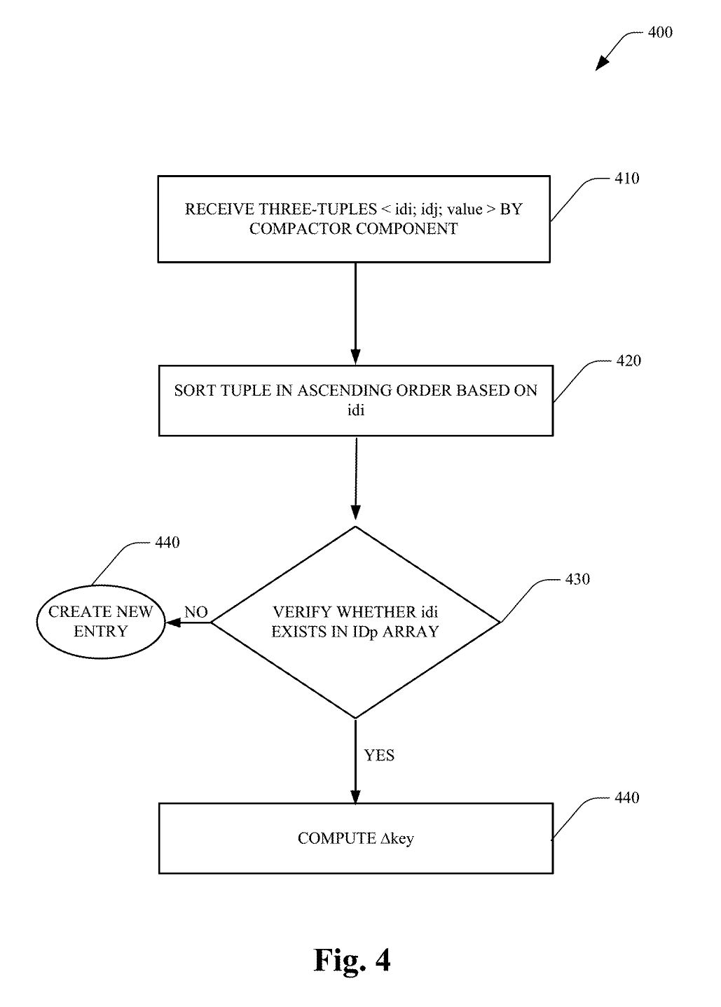

FIG. 4 illustrates a related methodology 400 that can be employed by the compactor component in accordance with an aspect of the subject disclosure. In one particular aspect, at 410 the compactor component can receive as input a set of three-tuples <idi; idj; value>. Subsequently and at 420, such three tuples can be sorted according to idi in ascending order, wherein tuples having the same idi can be further sorted according to idj ascendantly. Next, three arrays as well as three indicators can be respectively created, wherein a verification can be performed at 430 on a three tuple <idi; idj; value> to check whether idi exists in IDp Array (e.g., whether tuples with the same idi have been placed into the structure before). If not and in case that such represents the first tuple for idi, new entries can be created at 440 in each array, wherein each indicator can subsequently be moved to the next entry.

Alternatively, if there exist tuples with the same idi, a Δkey between idj and the key of latest BasicIDq entry can be computed at 450. Because the data set is sorted, the latest BasicIDq entry typically has a same idi with current three-tuple.

In a related aspect, a check can also be performed for whether the Δkey is smaller than 65535, the maximum value represented by a 2-Byte key of ΔIDq arrays. A new entry of ΔIDq can then be added and the indicator can subsequently move forward. Otherwise, Δkey is deemed too large to be represented by the key of ΔIDq, and an idj can subsequently be added as the key of a new BasicIDq entry and set its corresponding ΔIDq key to be 0. Such value can then put into the new ΔIDq entry. After all three-tuples are put into the structure, the empty entries in IDp Array can be padded. Each empty entry is set to be equal to the closest prior non-empty entry.

To this end, the following describes an example of code for such process as described above;

| Process for: Constructing the In-memory Structure | |
|---|---|
| Data: {< idi, idj, value > ...} | |
| Result: IDₚ | |
| 1 | /* Preprocess */ |

| | |
|---|---|
| 2 | sort tuples in ascending order of (idi, idj) ; |
| 3 | create IDₚ, BasicID_{q} and ΔID_{q} arrays ; |
| 4 | set ptIDₚ, ptBasicID_{q} and ptΔID_{q} to be 0 ; |

| | |
|---|---|
| 5 | /* Main loop */ |
| 6 | foreach < idi, idj, value > do |

| | |
|---|---|
| 7 | if IDₚ[idi] != −1 then |

| | |
|---|---|
| 8 | Δkey = idj − BasicID_{q}[ptBasicID_{q} − 1].key ; |
| 9 | if Δkey < 65535 then |

| | |
|---|---|
| 10 | ΔID_{q}[ptΔID_{q}].key = Δkey ; |
| 11 | ΔID_{q}[ptΔID_{q}].value = compressed(value); |
| 12 | ptΔID_{q} ++ ; |

| | |
|---|---|
| 13 | else |

| | |
|---|---|
| 14 | ΔID_{q}[ptΔID_{q}].key = 0 ; |
| 15 | ΔID_{q}[ptΔID_{q}].value = compressed(value) ; |
| 16 | BasicID_{q}[ptBasicID_{q}].key = idj ; |
| 17 | BasicID_{q}[ptBasicID_{q}].pointer = ptΔID_{q} ; |
| 18 | ptΔID_{q} ++ ; |
| 19 | ptBasicID_{q} ++ ; |

| | |
|---|---|
| 20 | end |

| | |
|---|---|
| 21 | else |

| | |
|---|---|
| 22 | ΔID_{q}[ptΔID_{q}].key = 0 ; |
| 23 | ΔID_{q}[ptΔID_{q}].value = compressed (value) ; |
| 24 | BasicID_{q}[ptBasicID_{q}].key = idj ; |
| 25 | BasicID_{q}[ptBasicID_{q}].pointer = ptΔID_{q} ; |
| 26 | IDₚ[idi] = ptBasicID_{q} ; |
| 27 | ptΔID_{q} ++ ; |
| 28 | ptBasicID_{q} ++ ; |

| | |
|---|---|
| 29 | end |

| | |
|---|---|
| 30 | end |
| 31 | /* Padding empty entries in IDp Array*/ |
| 32 | size = max(idi); |
| 33 | IDₚ[size] = ptBasicID_{q}; |
| 34 | for ptIDₚ: size-1 to 0 do |

| | |
|---|---|
| 35 | if IDₚ[ptIDₚ] == −1 then |

| | |
|---|---|
| 36 | IDp[ptIDₚ] = IDₚ[ptIDₚ + 1]; |

| | |
|---|---|
| 37 | end |

| | |
|---|---|
| 38 | return IDₚ ; |

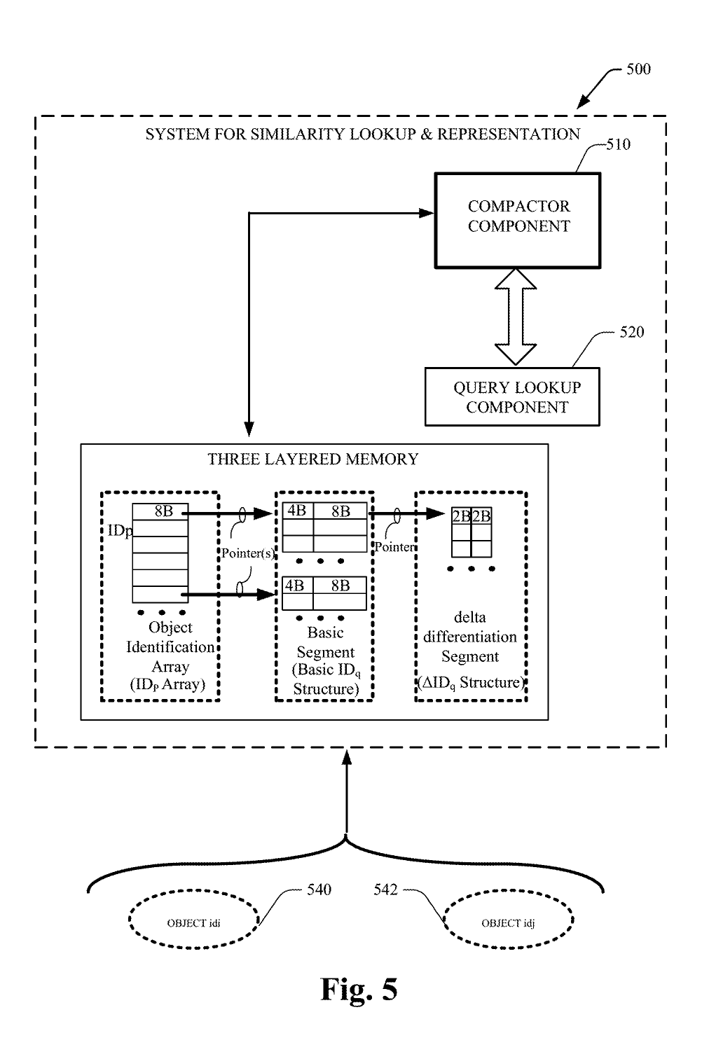

FIG. 5 illustrates a system for similarity look up and representation 500 that employs an in-memory structure and interacts with a query lookup component 520 and compactor component 510 according to a particular aspect of the subject innovation. The query lookup component 520 can employ query processing with the in-memory, wherein an input for the system 500 can include two Wikipedia article IDs idi and idj for objects 540, 542. An example of a code or instruction for operation of system 500 is indicated below (lines numeral “1” to “14” as numbered in the code below.)

| Process for: Querying the In-memory Structure. | |
|---|---|
| Data: idi, idj | |
| Result: similarity value | |
| 1 | check the range of idi and idj; |
| 2 | if IDp[idi + 1] != IDp[idi] then |

| | |
|---|---|
| 3 | ptBasicIDq = IDp[idi] ; |
| 4 | nBasicIDq = IDp[idi + 1] − IDp[idi] ; |
| 5 | i = binarySearch(idj, ptBasicIDq, nBasicIDq) ; |
| 6 | Δkey = idj − BasicIDq[i].key ; |
| 7 | ptΔIDq = BasicIDq[i].pointer ; |
| 8 | nΔIDq = BasicIDq[i + 1].pointer − pΔIDq ; |
| 9 | j = binarySearch(ΔIdq, ptΔIDq, nΔIDq) ; |
| 10 | if ΔIDq[j].key == Δkey then |

| | |
|---|---|
| 11 | return ΔIDq[j].value ; |

| | |
|---|---|
| 12 | end |

| | |
|---|---|
| 13 | end |
| 14 | return 0 ; |

The process associated with the above code can initially check if the two 1Ds all fall in the valid range of IDs (e.g., see line numeral “1” in above code). During initialization, the empty entries can be populated with the first-layer IDp array to be equal to the closest next non-empty entry. Moreover, a guard entry can be positioned at the end of the array. Accordingly, IDp[idi 1]-IDp[idi] can compute the number of second-layer entries of idi. A verification can be performed to check if there exists any second-layer entries for idi (e.g., see line numeral “2” in above code). If not, such typically indicates that idi does not have any similarity values and a “0” can be returned (e.g., see line numeral “14” in above code). Furthermore, pointer and number of entries of the second-layer corresponding to idi, can be obtained and binary search performed, to locate the BasicIDq entry immediately smaller than idj (see lines numeral “3” to “5” in above code.)

Δkey can also be computed (e.g., see line numeral “6” in above code), and a binary search can be performed in the third-layer data structure, to locate the matching entry (e.g., see lines 7-9). If the key of the located third-layer entry is exactly equal to Δkey, the similarity value can be returned.

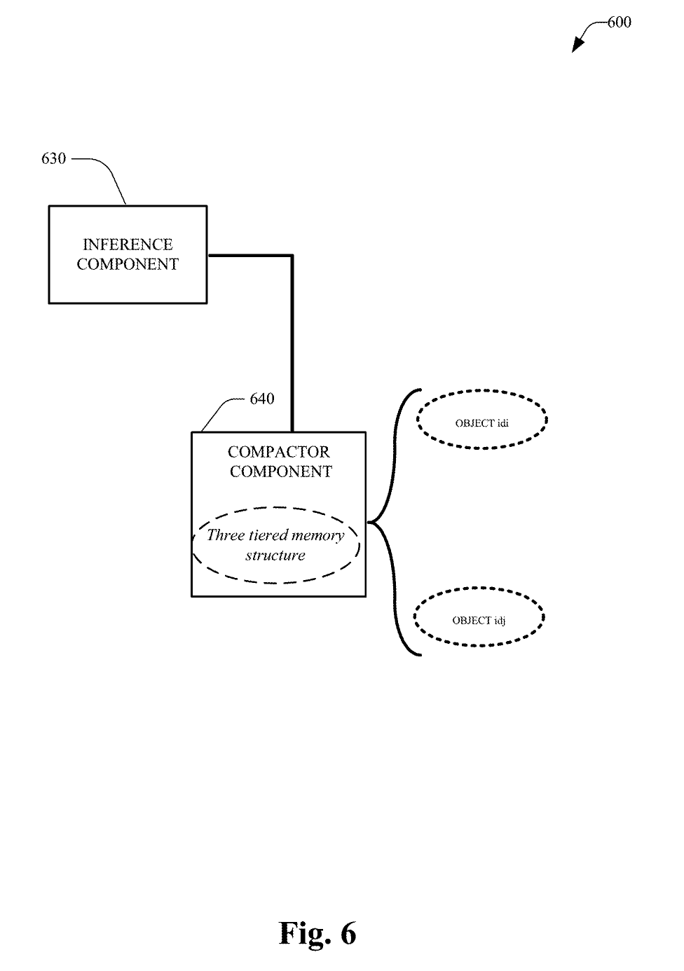

FIG. 6 illustrates a system 600 having an inference component 630 (e.g., an artificial Intelligence—AI) that can interact with the compactor component and/or the query lookup component, to facilitate inferring and/or determining when, where, how to store, represent and lookup similarity scores in a three layered memory structure according to an aspect of the subject disclosure.

As used herein, the term “inference” refers generally to the process of reasoning about or inferring states of the system, environment, and/or user from a set of observations as captured via events and/or data. Inference can identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The inference component 630 can employ any of a variety of suitable AI-based schemes as described supra in connection with facilitating various aspects of the herein described subject matter. For example, a process for learning explicitly or implicitly how parameters are to be created for training models based on similarity evaluations can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

The subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, SVM's can be configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

### Example of Networked and Distributed Environments

It is noted that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

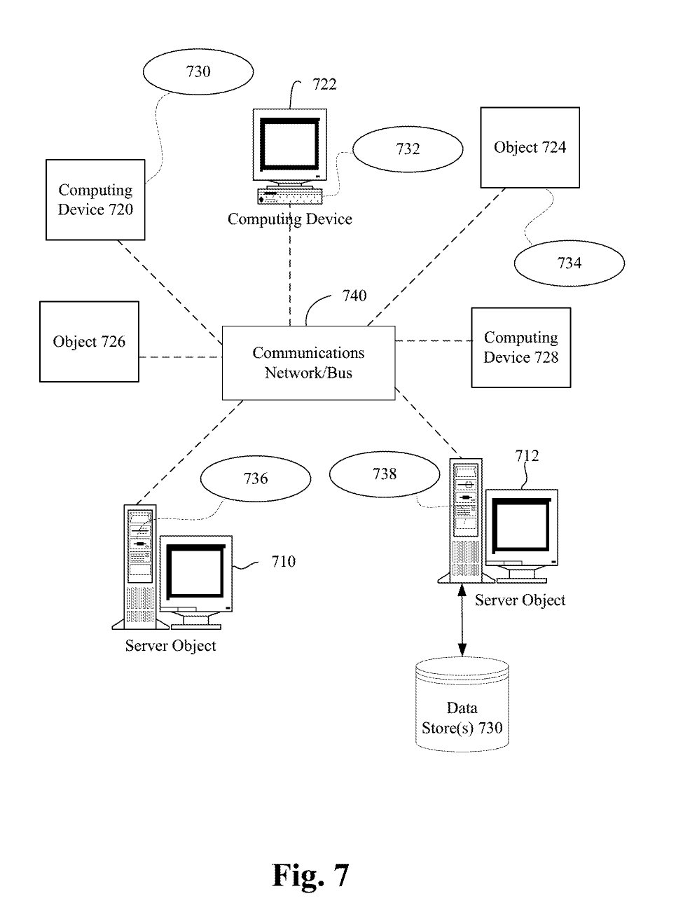

FIG. 7 provides a schematic diagram of an example for networked or distributed computing environment in which embodiments described herein can be implemented. The distributed computing environment includes computing objects 710, 712, etc. and computing objects or devices 720, 722, 724, 726, 728, etc., which can include programs, methods, data stores, programmable logic, etc., as represented by applications 730, 732, 734, 736, 738. It is noted that computing objects 710, 712, etc. and computing objects or devices 720, 722, 724, 726, 728, etc. can include different devices, such as personal digital assistants (PDAs), audio/video devices, mobile phones, MPEG-1 Audio Layer 3 (MP3) players, personal computers, laptops, tablets, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 can include other computing objects and computing devices that provide services to the system of FIG. 7, and/or can represent multiple interconnected networks, which are not shown. Each computing object 710, 712, etc. or computing objects or devices 720, 722, 724, 726, 728, etc. can also contain an application, such as applications 730, 732, 734, 736, 738, that might make use of an application programming interface (API), or other object, software, firmware and/or hardware, suitable for communication with or implementation of the various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used as examples of communications made incident to the systems as described in various embodiments.

Thus, a host of network topologies and network infrastructures, such as client/server, peer-to-peer, or hybrid architectures, can be utilized. The client can be a member of a class or group that uses the services of another class or group. A client can be a computer process, e.g., roughly a set of instructions or tasks, that requests a service provided by another program or process. A client can utilize the requested service without having to know all working details about the other program or the service itself.

As used in this application, the terms “component,” “module,” “system,” and the like are intended to refer to a computer-related entity, either hardware, software, firmware, a combination of hardware and software, software and/or software in execution. For example, a component can be, but is not limited to being, a process running on a processor, a processor, an object, an executable, a thread of execution, a program, and/or a computer. By way of illustration, both an application ruining on a computing device and/or the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

In a client/server architecture, particularly a networked system, a client can be a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc. provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances. Any of these computing devices can process data, or request transaction services or tasks that can implicate the techniques for systems as described herein for one or more embodiments.

A server can be typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 740 can be the Internet, for example, the computing objects 710, 712, etc. can be Web servers, file servers, media servers, etc. with which the client computing objects or devices 720, 722, 724, 726, 728, etc. communicate via any of a number of known protocols, such as the hypertext transfer protocol (HTTP). Computing objects 710, 712, etc. can also serve as client computing objects or devices 720, 722, 724, 726, 728, etc., as can be characteristic of a distributed computing environment.

### Example of Computing Device

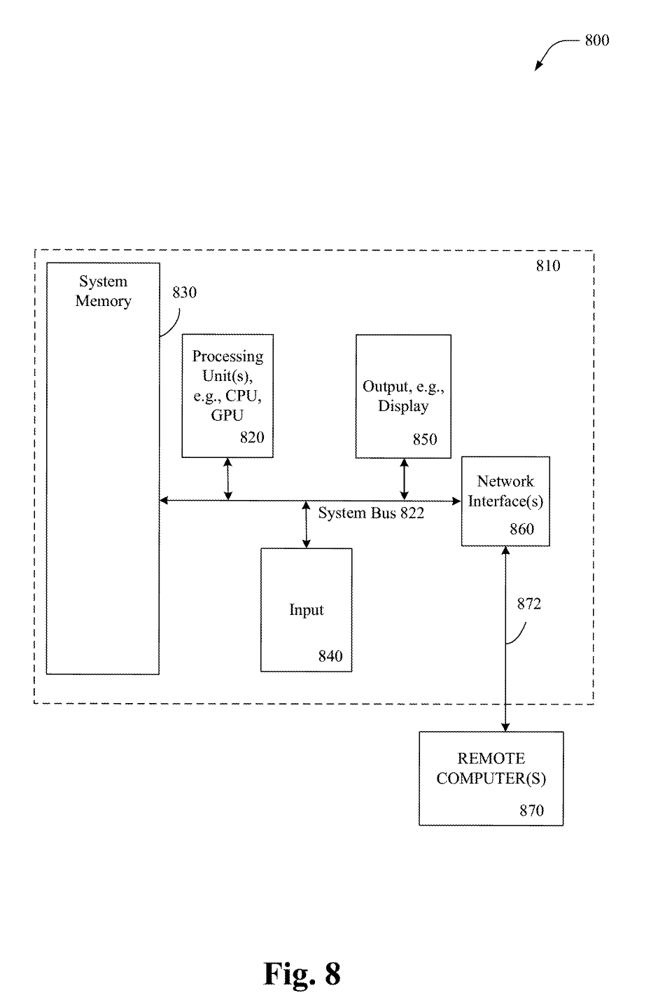

As mentioned, advantageously, the techniques described herein can be applied to any suitable device. It is to be understood, therefore, that handheld, portable and other computing devices and computing objects of all kinds are contemplated for use in connection with the various embodiments, e.g., anywhere that a device may wish to read or write transactions from or to a data store. Accordingly, the below remote computer described below in FIG. 8 is but one example of a computing device. Additionally, a suitable server can include one or more aspects of the below computer, such as a media server or other media management server components.

Embodiments can be partly implemented via an operating system, for use by a developer of services for a device or object, and/or included within application software that operates to perform one or more functional aspects of the various embodiments described herein. Software can be described in the general context of computer executable instructions, such as program modules, being executed by one or more computers, such as client workstations, servers or other devices. It is noted that computer systems have a variety of configurations and protocols that can be used to communicate data, and thus, no particular configuration or protocol is to be considered limiting.

FIG. 8 thus illustrates an example of a suitable computing environment 800 in which one or aspects of the embodiments described herein can be implemented, although as made clear above, the computing environment 800 is only one example of a suitable computing environment and is not intended to suggest any limitation as to scope of use or functionality. Neither is the computing environment 800 to be interpreted as having any dependency or requirement relating to any one or combination of components illustrated in the example of computing environment 800.

With reference to FIG. 8, an example of computing environment 800 for implementing various aspects includes a computing device in the form of a computer 810 is provided. Components of computer 810 can include, but are not limited to, a processing unit 820, a memory 830, and a system bus 822 that couples various system components including the system memory to the processing unit 820. Computer 810 can for example implement systems and/or components described in connection with various aspect of the subject disclosure.

Computer 810 typically includes a variety of computer readable media and can be any available media that can be accessed by computer 810. The memory 830 can include computer storage media in the form of volatile and/or nonvolatile memory such as read only memory (ROM) and/or random access memory (RAM). By way of example, and not limitation, memory 830 can also include an operating system, application programs, other program modules, and program data.

A user can enter commands and information into the computer 810 through input devices 840, non-limiting examples of which can include a keyboard, keypad, a pointing device, a mouse, stylus, touchpad, touch screen, trackball, motion detector, camera, microphone, joystick, game pad, scanner, video camera or any other device that allows the user to interact with the computer 810. A monitor or other type of display device can be also connected to the system bus 822 via an interface, such as output interface 850. In addition to a monitor, computers can also include other peripheral output devices such as speakers and a printer, which can be connected through output interface 850.

The computer 810 can operate in a networked or distributed environment using logical connections to one or more other remote computers, such as remote computer 870. The remote computer 870 can be a personal computer, a server, a router, a network PC, a peer device or other common network node, or any other remote media consumption or transmission device, and can include any or all of the elements described above relative to the computer 810. The logical connections depicted in FIG. 8 include a network 872, such local area network (LAN) or a wide area network (WAN), but can also include other networks/buses e.g., cellular networks.

As mentioned above, while examples of embodiments have been described in connection with various computing devices and network architectures, the underlying concepts can be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques detailed herein. Thus, embodiments herein are contemplated from the standpoint of an API (or other software object), as well as from a software or hardware object that implements one or more aspects described herein. Also, various embodiments described herein can have aspects that are wholly in hardware, partly in hardware and partly in software, as well as in software.

Computing devices typically include a variety of media, which can include computer-readable storage media and/or communications media, in which these two terms are used herein differently from one another as follows. Computer-readable storage media can be any available storage media that can be accessed by the computer, can be typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, electrically erasable programmable read only memory (EEPROM), flash memory or other memory technology, compact disc read only memory (CD-ROM), digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal (e.g., a carrier wave or other transport mechanism) and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (RF), infrared and other wireless media.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessor and/or other electronic units designed to perform the functions described herein, or a combination thereof

When the embodiments are implemented in software, firmware, middleware or microcode, program code or code segments, they can be stored in a machine-readable medium (or a computer-readable storage medium), such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules or components (e.g., procedures, functions, and so on) that perform the functions described herein. The software codes can be stored in memory units and executed by processors. A memory unit can be implemented within the processor or external to the processor, in which case it can be communicatively coupled to the processor via various structures.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims.

The aforementioned systems have been described with respect to interaction between several components. It is noted that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components can be combined into a single component providing aggregate functionality or divided into several separate sub-components, and that any one or more middle layers, such as a management layer, can be provided to communicatively couple to such sub-components in order to provide integrated functionality. Any components described herein can also interact with one or more other components not specifically described herein but generally known by those of skill in the art.

In view of the exemplary systems described above methodologies that can be implemented in accordance with the described subject matter can be better understood with reference to the flowcharts of the various figures. While for purposes of simplicity of explanation, the methodologies are shown and described as a series of blocks, it is to he understood and noted that the claimed subject matter is not limited by the order of the blocks, as some blocks can occur in different orders and/or concurrently with other blocks from what is depicted and described herein. Where non-sequential, or branched, flow is illustrated via flowchart, it is noted that various other branches, flow paths, and orders of the blocks, can be implemented which achieve the same or a similar result. Moreover, not all illustrated blocks can be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be affected across a plurality of devices. The subject disclosure is not to be limited to any single embodiment, but rather can be construed in breadth, spirit and scope in accordance with the appended claims.

What is claimed is:

1. A system that facilitates a similarity-score-lookup, comprising:
a compactor component that maintains data related to similarity among objects, via a layered memory structure; and
a divider component that divides identification for each of the objects in to a basic segment and a delta differentiation segment,
wherein a first layer of the layered memory structure stores object identifications, a second layer of the layered memory structure stores the basic segment, and a third layer of the layered memory structure stores the delta differentiation segment.

2. The system of claim 1 further comprising a sorting component that sorts tuples associated with objects in an ascending order.

3. The system of claim 1, wherein objects are representable as a three-tuple of <i, j, score>, wherein i an j represent integers that indicate object identifications, and score represents a floating number that ranges from 0 to 1.

4. The system of claim 2, wherein the sorting component and the divider component are part of the compactor component.

5. The system of claim 3 further comprising an inference component that facilitates compacting a data structure associated with the similarity score lookup in to the layered memory structure.

6. The system of claim 3 further comprising a pointer that one of connects the first layer to the second layer, or the second layer to the third layer.

7. The system of claim 2, wherein the similarity among objects computed in context of a database content.

8. A system that facilitates a similarity-score-lookup between objects comprising:
at least one memory that stores computer-executable instructions;
at least one processor that facilitates execution of the computer-executable instructions to:
sort tuples of objects associated with the similarity-score-lookup;
divide identification for an object to a basic segment and a delta differentiation segment;
store the basic segment in a layer of a three layered memory structure and the delta differentiation segment in another layer of the three layered memory structure.

9. The system of claim 8, the at least one processor further facilitates computer-executable instructions to similarity among objects computed in context of Wikipedia archives.

10. The system of claim 8, the at least one processor further facilitates execution of the computer-executable instructions to compress a 4 byte data structure into a 2 byte delta differentiation segment.

11. The system of claim 8, the at least one processor further facilitates instructions to point from the delta differentiation segment to beginning of a similarity records in a first layer of the three layered memory structure.

12. The system of claim 8, the at least one processor further facilitates instructions to store similarity scores a four digits in a 2-byte integer of a third layer in the three layered memory structure.

13. A method comprising:
storing tuples associated with a similarity score lookup between objects in a three layered memory structure;
dividing identification for an object to a basic segment and a delta differentiation segment; and
storing the basic segment in a layer of the three layered memory structure, and storing the delta differentiation segment in another layer of the three layered memory structure.

14. The method of claim 13 further comprising inferring representation of a lookup similarity score in a three layered memory structure.

15. The method of claim 13 further comprising locating an entry that matches a delta differentiation segment in the third layer, to return a similarity value.
